(19) United States
(12) Patent Application Publication
(10) Pub. No.: US 2007/0185907 A1
(43) Pub. Date: Aug. 9, 2007

(54) Method and apparatus for displaying information on personal relationship, and computer product

(75) Inventor: Terunobu Kume, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/412,895

(22) Filed: Apr. 28, 2006

(30) Foreign Application Priority Data
Jan. 20, 2006 (JP) 2006-012844

(51) Int. Cl. G06F 17/00

(52) U.S. Cl. 707/104.1

(57) ABSTRACT

An apparatus for displaying information on personal relationship include, an extracting unit that extracts pieces of metadata each including information on a person, from electronic data that includes identification information identifying each person; a linking unit that links the pieces of the metadata with each other based on co-occurrences of the identification information; a determining unit that determines strength of relationships between people in liked pieces of the metadata, based on identification information that is used by the linking unit to link the pieces of the metadata; a displaying unit that graphically displays the relationships based on the linked pieces of metadata and the strength of relationships.

### CROSS-REFERENCE TO RELATED APPLICATIONS

This application is based upon and claims the benefit of priority from the prior Japanese Patent Application No. 2006-012844, filed on Jan. 20, 2006, the entire contents of which are incorporated herein by reference.

### BACKGROUND OF THE INVENTION

1. Field of the Invention

The present invention relates to a technology for displaying information on personal relationship among a group of people.

2. Description of the Related Art

In an organization such as a company, when a personnel reshuffle is conducted, it is often a case that people lose contact with one that has been able to contact because of a change of grouping. Although information on a personnel reshuffle of core employees is generally made open, for example, in newspapers, information on a personnel reshuffle of ordinary employees is usually not made open.

Similarly, inside a company, although information on members in a division is made open, grouping information that indicates who belongs to which group is not made open in many cases. Even when the grouping information is made open, after a personnel reshuffle, the grouping information is often not updated.

In an organization, besides business-related formal communities, informal communities such as a section, informal communities are present. The informal community does not refer to personal friendships such as friends, but refers to informal societies such as work groups for people having common problems to gather and discuss methods of solving the problems, and workshops for exchanging opinions and information as to the latest technologies.

These informal communities play a very important role for project members to advance their work smoothly and efficiently. Human resources and material resources can be efficiently input by enabling the organization to grasp the actual state of a project as an organization and enabling the person in charge of the work to find out communities necessary for information collection and consultation according to the state of the project.

However, these informal communities vary every moment following a trend of a general society, working state of project members, and a progress of the project. Therefore, to grasp the actual state of those communities is difficult. Especially, in a large company, the number of projects alone is large. For the informal communities generated from those projects, it is even more difficult for those outside the communities to find out the existence of the communities.

To aid in finding informal communities, a Know-Who technology to find people that know information is applied to a method of finding communities (see The 71st Information Science Basic Workshop of the Information Processing Society of Japan, May 22, 2003, F1-71-2, “Semantic Groupware WorkWare++ and Its Application to Know-Who Retrieval” by Yoshinori Katayama, et al.). According to this method, personal relationships are extracted from information on schedules and information on participants in meeting records, and informal communities are found from personal relationships in those pieces of information.

“Know-Who” refers to knowing the person who has necessary knowledge, and at least, knowing who knows the person. In another method, activities of users are estimated by combining schedules and sensor information (Groupware and Network Service Workshop 2005, Vol. 2005, No. 14, p. 13, Oct. 18, 2005, “Proposal of State Recognition Approach Utilizing Schedule and Sensor Information” by Masayuki Okamoto and Hideo Umeki). A certain degree of effect has been obtained in the above two methods.

To realize “Know-Who” described above, characteristic information (profile) of target people must be collected in advance. When profiles of the people are registered manually, complex work of the registration leads to scarceness of the registered data, obsolete information, and information manipulation such as false statements and concealment of disadvantageous data. Moreover, the more able a person is, the less time the person has to register such information. Therefore, Know-Who does not function well in practice. Even if necessary data is collected, Know-Who cannot be used effectively if the data is not retrieved speedily from various facets and is not capable of presenting a result of retrieval understandably to users.

A personal relationship display method capable of automatically collecting information on relationships between people that appear in various electronic data that includes information to identify people, such as names (for example, Japanese Patent Application Laid-Open Publication No. 2005-108123).

In the above conventional techniques, however, because all pieces of personal relationship information accumulated from the past to the present is handled equally, communities in the past that have finished roles thereof are emphasized. Therefore, personal relationships at present can not be accurately reflected.

For example, when a personnel reshuffle has just been conducted, even if schedules of members of new groups are co-occurred, the number of times of co-occurrences is not many. Therefore, the groups in the past before the personnel reshuffle are more strongly expressed because the number of times of co-occurrences of those groups is relatively more. Therefore, personnel relationships at present can not be accurately reflected.

When information on co-occurrences of schedules of actions or participants of meetings is utilized, because each piece of personnel relationship information accumulated from the past to the present is handled equally, unnecessary personal relationships are extracted. Therefore, personnel relationships at present can not be accurately reflected.

The term “meeting” includes even one that is not likely to have only members of a group gathered therein, such as a “division meeting” and a “seminar” that can include people from outside of the group, and one that is highly likely to have only members of a group gathered therein such as a “group progress meeting”.

In other words, in the conventional techniques described above, communities are formed without distinguishing types of information such as those for a “division meeting”, a “seminar”, and a “group progress meeting” regardless of the characters of a meeting. Therefore, personnel relationships at present can not be accurately reflected.

In addition, if communities that have finished the roles thereof and unnecessary communities are expressed strongly, newly generated communities become difficult to be found.

### SUMMARY OF THE INVENTION

It is an object of the present invention to at least solve the above problems in the conventional technologies.

An apparatus according to one aspect of the present invention is for displaying information on personal relationship. The apparatus includes an extracting unit configured to extract a plurality of pieces of metadata each including information on a person, from electronic data that includes identification information identifying each person; a linking unit configured to link the pieces of the metadata with each other based on co-occurrences of the identification information; a determining unit configured to determine strength of relationships between people in liked pieces of the metadata, based on identification information that is used by the linking unit to link the pieces of the metadata; and a displaying unit configured to graphically display the relationships based on the linked pieces of metadata and the strength of relationships.

A method according to another aspect of the present invention is of displaying personal relationship information. The method includes extracting a plurality of pieces of metadata each including information on a person, from electronic data that includes identification information identifying each person; linking the pieces of the metadata with each other based on co-occurrences of the identification information; determining strength of each relationships between people in liked pieces of the metadata, based on identification information that is used to link the pieces of the metadata at the linking; and graphically displaying the relationship based on the linked pieces of metadata and the strength of relationships.

A computer-readable recording medium according to still another aspect of the present invention stores therein a computer program for realizing a method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a personal relationship display apparatus according to an embodiment of the present invention;

FIG. 2 is a block diagram of the personal relationship display apparatus;

FIG. 3 is a table showing metadata of a person stored in a metadata database (DB);

FIG. 4 is a table showing metadata of a document stored in the metadata DB;

FIG. 5 is a table showing metadata of a schedule stored in the metadata DB;

FIG. 6 is a table showing metadata of a schedule stored in the metadata DB;

FIG. 7 is a conceptual view of a part of the metadata stored in the metadata DB;

FIG. 8 is a table showing linked metadata of schedules;

FIG. 9 is a schematic for illustrating relationships among people associated by the linked metadata;

FIG. 10 is a schematic for illustrating relationships among people associated by the linked metadata;

FIG. 11 is a schematic for illustrating relationships among people associated by the linked metadata;

FIG. 12 is a schematic of a display of a conventional personal relationship map;

FIG. 13 is a schematic of a display of a personal relationship map according to the embodiment; and

FIG. 14 is a schematic of a display of the personal relationship map according to the embodiment; and

FIG. 15 is a flowchart of a display process by the personal relationship display apparatus.

### DETAILED DESCRIPTION OF THE PREFERRED EMBODIMENTS

Exemplary embodiments according to the present invention will be explained in detail with reference to the accompanying drawings.

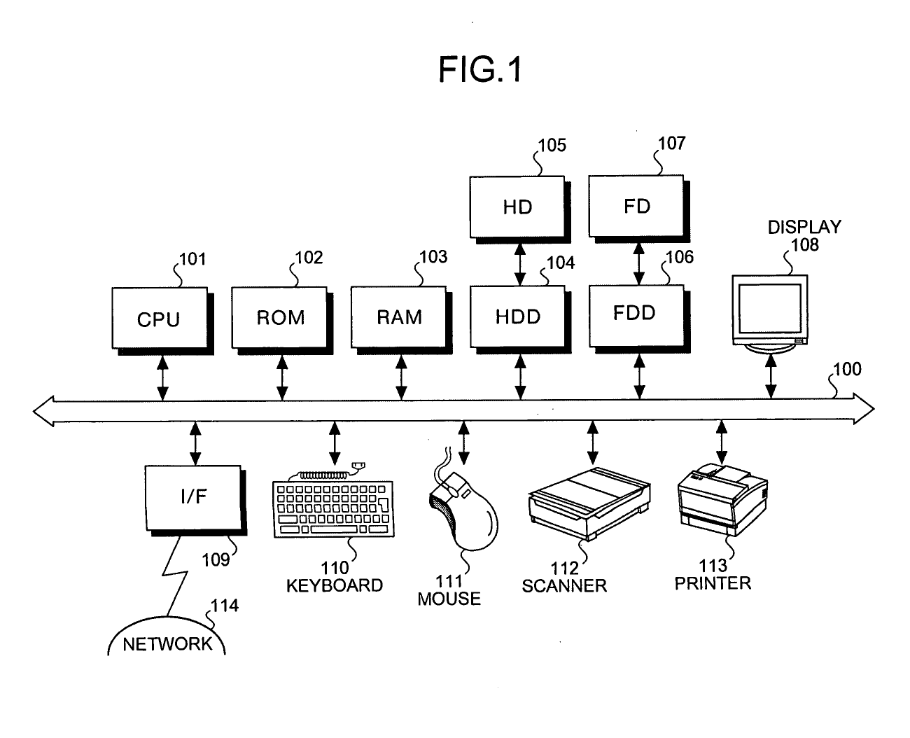

FIG. 1 is a schematic of a personal relationship display apparatus according to an embodiment of the present invention. S shown in FIG. 1, the personal relationship display apparatus includes a central processing unit (CPU) 101, a read-only memory (ROM) 102, a random access memory (RAM) 103, a hard disk drive (HDD) 104, a hard disk (HD) 105, a flexible disk drive (FDD)106, a flexible disk (FD) 107 as an example of a removable recording medium, a display 108, an interface (I/F) 109, a keyboard 110, a mouse 111, a scanner 112, and a printer 113. Each component is connected by a bus 100 with each other.

The CPU 101 administers the entire personal relationship display apparatus. The ROM 102 stores programs such as a boot program. The RAM 103 is used as a work area of the CPU 101. The HDD 104 controls reading/writing of data from/to the HD 105 according to a control of the CPU 101. The HD 105 stores data written according to a control of the HDD 104.

The FDD 106 controls reading/writing of data from/to the FD 107 according to a control of the CPU 101. The FD 107 stores the data written by a control of the FDD 106, causes the personal relationship display apparatus to read the data stored in the FD 107.

As a removable recording medium, besides the FD 107, a compact-disc read-only memory (DD-ROM), a compact-disc recordable (CD-R), a compact-disc rewritable (CD-RW), a magneto optical (MO) disk, a digital versatile disk (DVD), and a memory card may be used. In addition to a cursor, and icons or tool boxes, the display 108 displays data such as texts, images, functional information, etc. This display 108 may employ, for example, a cathode ray tube (CRT), a thin film transistor (TFT) liquid crystal display (LCD), a plasma display, etc.

The I/F 109 is connected to a network 114 such as the Internet, through a communication line and is connected to external apparatuses through the network 114. The I/F 109 administers the network 114 and an internal interface and controls input/output of data to/from external apparatuses. For example, a modem, a local area network (LAN) adapter, etc., may be employed as the I/F 109.

The keyboard 110 includes keys for inputting letters, digits, various instructions, etc., and executes input of data. The keyboard 110 may be a touch-panel-type input pad or a numeric keypad etc. The mouse 111 executes shift of the cursor, selection of an region, or shift and size change of windows. The mouse 111 may be a track ball or a joy stick that similarly includes the function as a pointing device.

The scanner 112 optically reads images and captures image data into the personal relationship display apparatus. The scanner 112 may have an optical character reader (OCR) function. The printer 113 prints image data and text data. For example, a laser printer or an ink jet printer may be employed as the printer 113.

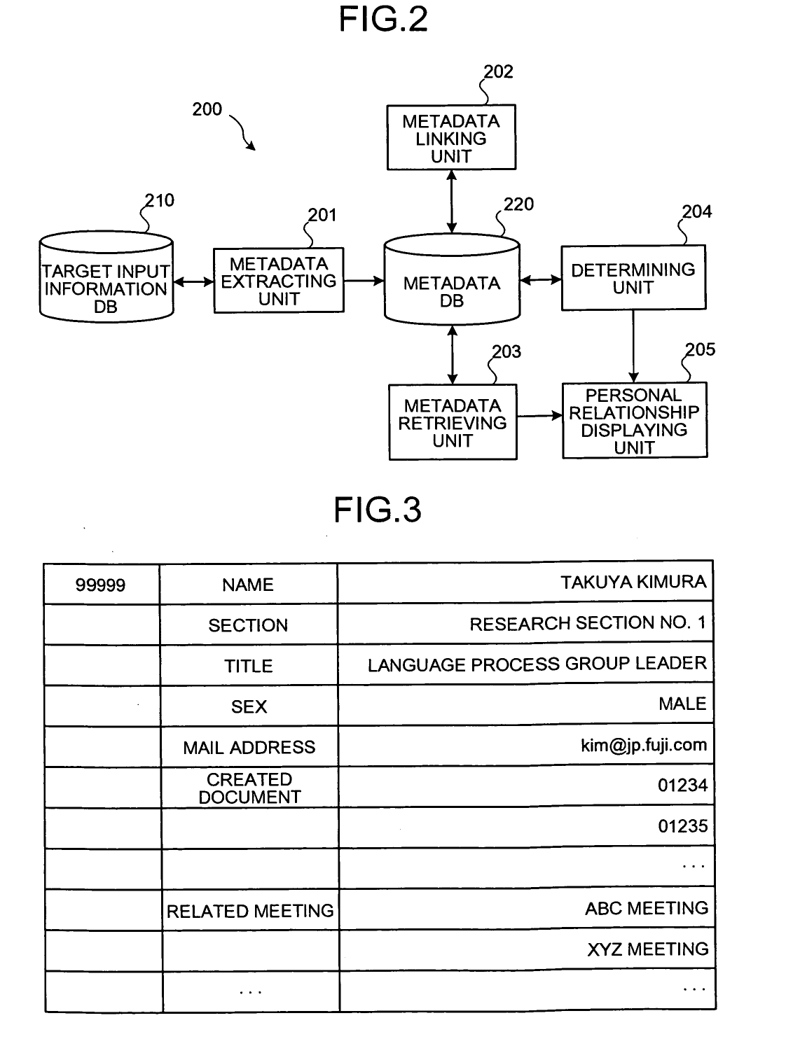

FIG. 2 is a block diagram of the personal relationship display apparatus. As shown in FIG. 2, a personal relationship display apparatus 200 includes a target input information DB 210, a metadata extracting unit 201, a metadata linking unit 202, a metadata DB 220, a metadata retrieving unit 203, a determining unit 204, and a personal relationship displaying unit 205.

The target input information DB 210 is a database that retains various types of data (target input information) that are the extraction origins of metadata. As this target input information, all types of data including a plurality of personal names (not only personal names but also any information that can be used to identify a person) may be utilized. One characteristic of the present invention is that the present invention constructs metadata by incorporating not only data that is related to people and the relationships among the people are fixed and explicit such as electronic mail and schedules but also data that do not always include a plurality of personal names and the relationships among the names are not always clear, into the metadata.

The target input information can be collected from not only the inside of a set of members who utilize this apparatus, such as the inside of groups such as companies and societies, but also data outside the groups or data both inside and outside the groups. A specific example of the target input information is shown classified by origin, for example, as follows.
(1) In-Group Target Input Information
(1-1) Electronic Data Created by Members Themselves

The data includes electronic documents (regardless of format) such as meeting records, reports, agreements, etc.; data relating to communication among members such as an electronic mail, a bulletin board system (BBS), a chat, etc.; schedules of members registered in a scheduler; and personal information, such as a name, a section assigned, a title, of each member registered in an employee DB.

(1-2) Data Relating to an Accessing Method to Data of Each Member

Members having a close relationship with each other often use the same tools and applications, which is the accessing method of the members to data, by necessity on business. For example, when a member of a section “A” dealing with sales uses a special tool that is used only for the work of a section “B” dealing with engineering, it is assumed that the member has a certain relationship with the work of the section “B” and the members thereof.

(1-3) Data Relating to the Access Log to Data of Each Member

Keywords input as retrieval conditions often directly reflect work contents of an operator. For example, a member “a” of the section “A” and a member “b” of the section “B” concurrently execute respectively retrieval of a document using a specific terminology, it is assumed that the members have a certain relationship between the members regardless of which data each of them respectively has accessed. Not only which data has been accessed but also the frequency of accesses can be a clue to presence or absence of the relationship.

(2) Target Input Information Outside Group

This information includes electronic documents, such as a web-page, a newspaper article, a magazine article, a report, and an introduction text, that provide certain objective information on a group and the members thereof. However, because the information especially on the Internet is massive and has qualitative dispersion, it is necessary to screen the information to leave only the portion of the information for which reliability and accuracy to a certain degree can be secured such that transmission origins for the portion are reliable and the portion is checked by a reliable institute.
(3) Target Input Information Inside and Outside Group

This information relates to accesses to members in a group or communication with the members in the group and is, for example, an electronic mails exchanged among non-members and the members, business name card data read optically by a scanner or read electronically from a radio frequency identification (RFID) tag. When the business name card data is read from an RFID tag, the data, the time, and the place can be collected in addition to a personal name and the section to which the person is assigned.

The target input information of (1) to (3) may be registered in a file server commonly used by the members, or is registered in a personal file server. As far as the personal relationship display apparatus 200 is connected through the network 114 with those servers, data can be collected from either of those servers technically. However, in the latter case, consent of the person concerned should be obtained in advance considering timing and privacy of the person.

The metadata extracting unit 201 extracts metadata relating to a person from electronic data including person identifying information that can identify the person, and more specifically, extracts metadata relating to a person, a document, a schedule, etc., from the various types of target input information in the target input information DB 210.

The metadata linking unit 202 associates the metadata extracted by the metadata extracting unit 201 based on the co-occurrences of the person identifying information in the electronic data, and more specifically, creates and clarifies further metadata (secondary metadata) by mining (relating) among metadata extracted by the metadata extracting unit 201. The metadata DB 220 is a database that retains metadata obtained by the above process.

A document created by a member himself/herself is a material that directly shows the contents of the work and skills of the member. Therefore, metadata of the document are stored in the metadata DB 220 being associated with the metadata of the member. Specifically, the metadata of the document are the title, the author, the time of creation, the time of updates (change history), the place of use (related meetings and distribution destinations, etc.), and key word groups extracted from the document text of the document.

When a plurality of personal names (regardless of being members or non-members) appear in the same document, certain relationships are highly likely to exist among these members/non-members. These metadata of the members/non-members co-occurred in the same document are also related to each other and are stored in the metadata DB 220.

Generally, among names appearing in the same document, it can be considered that the closer the positions at which the names appear are from each other, the stronger the relationship is, and the farther the positions are from each other, the weaker the relationship is. The strength of a relationship among personal names is calculated depending to a structure (phrase, paragraph, etc.) of the document that carries the personal names. More specifically, it is assumed that a strong relationship exists among personal names listed in the item of “attendees” in a meeting record. When a personal name “A” and a personal name “B” appearing in this document coincide with a pattern as “<personal name> and <personal name>” by pattern matching, a strong relationship is considered to exist between A and B.

On the contrary, personal names appearing in related documents (a group of documents grouped based on a same viewpoint) are likely to have a certain relationship though the names do not always appear in the same document. The related documents may be once combined as one document and personal names appearing in the document after being combined may be related to each other. In this combining, a predetermined algorithm, such as clustering, relating by key-word co-occurrence, and a combining rule, is used.

When a strong relationship can be suggested from (1-2) and/or (1-3) for personal names that only have a weak relationship as far as the above (1-1) among the target input information is noted for the names, the strength of the relationship (degree of relationship) estimated from (1-1) is added with the strength of relationship estimated from (1-2) and/or (1-3). In the relating, by utilizing information of (2) and/or (3) as an assistance, relationships among people can be grasped more accurately and more comprehensively than by noting only data created by the members themselves.

When among information in (2), information on the Internet is used, various cleaning techniques to exclude garbage information are necessary for determining the range of personal names to be extracted, extracting methods, etc., in addition to screening of information to be used. For example, because pieces of information on the Internet are not always in the same format, a strong name identification by a predetermined dictionary information base or a rule base is necessary.

The description format of metadata may be of any type. However, a conventional relational database (RDB) is not suitable for storing information on an item that is extensive and multi-faceted and is always changing, such as relationships among people. In the present invention, as a format of metadata, a resource description framework (RDF) that is a description format of metadata in a semantic WEB is employed.

The metadata retrieving unit 203 retrieves data to be visualized by the personal relationship displaying unit 205 described later, from the metadata stored in the metadata DB 220. That is, this can be described as screening of metadata to be visualized.

Because the metadata in the metadata DB 220 is quite tremendous and huge, to display all of the metadata simultaneously is impossible. Therefore, the metadata retrieving unit 203 causes an operator to specify which metadata are used (conditions for metadata to be used) in the metadata in the metadata DB 220, retrieves the metadata that fit to the conditions from the metadata DB 220, and delivers the retrieved metadata to the personal relationship displaying-unit 205.

For example, when a key word that is characteristic to a technique or a topic is designated, only the metadata of members/non-members relating to the technique or the topic are screened from the metadata in the metadata DB 220, and relationships of each person are displayed in a personal relationship map. Depending on the variation of this screening, personal relationships can be cut out from a various viewpoints from even the same metadata DB 220 and can be displayed.

As the conditions of screening, the following conditions can be designated specifically. Other conditions than the following conditions or combinations of a plurality of conditions are possible.
The number of paths of relationships (personal relationships)
The number of people
The section or group to which each person belongs
Profile information of people
Key words
Strength of each relationship

The determining unit 204 determines the strength between the people grasped from the metadata related by the metadata linking unit 202 (hereinafter, “linked metadata”) based on person identifying information generated by relating linked metadata using co-occurrences (hereinafter, “co-occurrence-related person identifying information”).

The metadata to be visualized can also be screened using the metadata retrieving unit 203 described above. However, accurate personal relationship information can not be displayed if exact retrieval conditions have not been specified by a user. Therefore, the determining unit 204 determines the strength between people by linked metadata using the following process. More specifically, the strength is determined using the following <1> to <4> criteria. These <1> to <4> criteria may be respectively used separately or may by used in a combination.
<1> The number of days that have passed from the meeting to be identified by person identifying information relating to the co-occurrence.
<2> The type of the meeting to be identified by person identifying information relating to the co-occurrence.
<3> The number of attendees of the meeting to be identified by person identifying information relating to the co-occurrence. <4> Information on the sections to which the attendees belong, of the meeting to be identified by person identifying information relating to the co-occurrence.

The criterion <1> is used to, for example, attenuate the strength of relationships between people corresponding to the number of days that have passed from the date and the time of the start to the current date and the current time. That is, how much time has passed is calculated referring to the current date and the strength of the relationships between the linked metadata is weighted corresponding to the time that has passed. As a model of a calculating method of weighting, the following model can be considered.

When the newest informal community having an activity of some degree is desired to be extracted, a model that is applied with a linear function and has the weight thereof decreasing monotonously as the time passes, is utilized. As a linear function that calculates a weight, for example, the following Equation 1 is applied.
g=(1/d)xt+1 (1)
where g is the weight, d is the number of days for which data exist in the liked metadata, and t is the number of days that have passed.

When a newly formed informal community having an activity that seems to become active from now is desired to be extracted, a model that is applied with an inverse-proportional function (for example, an exponential function) is applied and has the weight thereof that is made very small when the time that has passed is very long, is utilized.

When a change of a formal community is desired to be extracted, a model having the weight thereof that is decreased stepwise at the timing of a personnel reshuffle, etc., can be considered.

Under the criteria <2> to <4>, whether or not a community is important to display judging from information such as the name of the meeting, etc., is judged.

Under the criterion <2>, the weighting using the type of the meeting is executed using specific key words included in the name of the meeting. For example, the words that identify formal communities and the words that identify informal communities are classified from the words are included in the linked metadata relating to a schedule table, and that often appear. For example, when the words that identify a formal meeting such as “Division Meeting”, “Briefing”, and “Group Meeting” are included, the weight is reduced. On the other hand, when the words that identify an informal meeting such as “Workshop”, and “Patent Screening Meeting” are included, the weight is increased.

Under the criterion <3>, the weighting is executed using the number of attendees of a meeting. When the number of attendees has exceeded a certain number, it is unlikely that all of the attendees communicate with each other. Therefore, the following rule is set considering the number of the attendees within a range within which all of the attendees can communicate with each other. For example, when the number of attendees has exceeded nine, the weight is reduced, and when the number of the attendees is five or less, the weight is increased.

Under the criterion <4>, the weighting is executed using information on the sections to which the attendees belong. The following rule is set considering that when the section of the attendees is one type, the meeting in this case is likely to be a meeting of a formal community, and when the sections are two types, these two sections are likely to be a client and a section in the company. For example, when the types of sections to which the attendees belong are two or less, the weight is reduced, and when the types are three or more, the weight is increased.

The personal relationship displaying unit 205 displays graphically the relationships among people based on the linked metadata and the strength of the relationships between the people from the linked metadata determined by the person identifying information relating to the co-occurrences. More specifically, for example, a web-shaped personal relationship map is displayed that is produced by connecting image data identifying people with each other using straight lines corresponding to the strength of relationships among people determined by the determining unit 204. In this case, the linked metadata may be screened by the metadata retrieving unit 203.

As the image data that identify people, personal relationship information can be recognized intuitively by displaying icons of the names of the people, faces, photographs, and other metadata (electronic documents, etc.) related to the people. This personal relationship map displays dedicatedly the relationships among people.

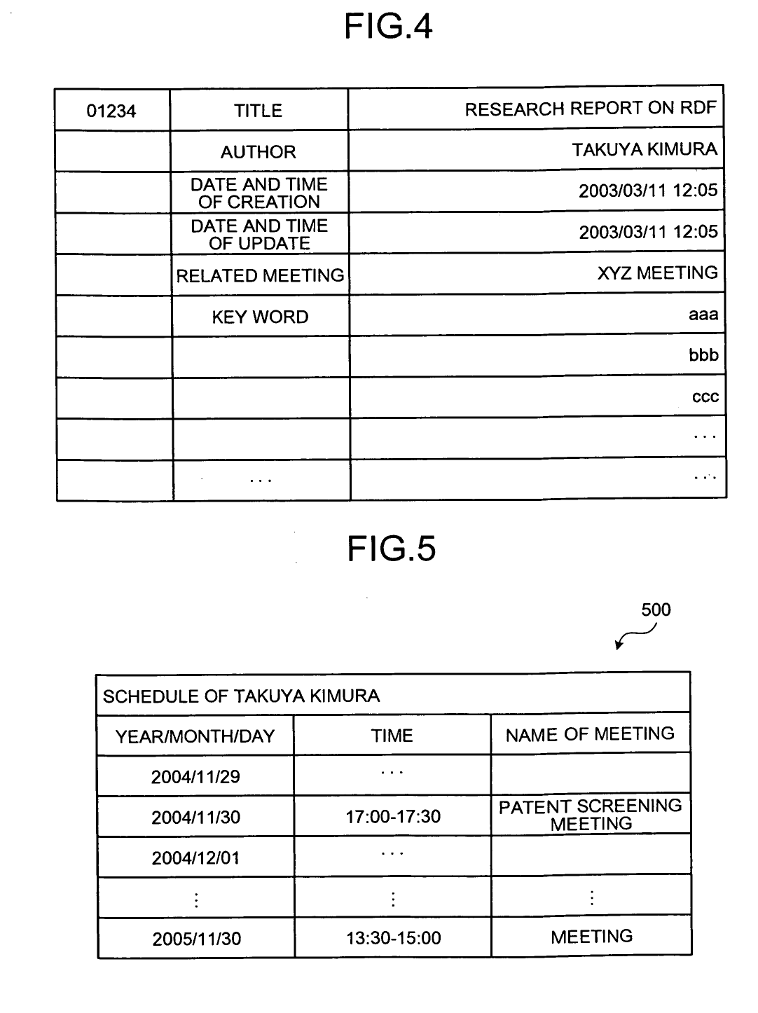

FIG. 3 to FIG. 6 are tables showing the metadata retained in the metadata DB 220. FIG. 3 illustrates an example of the metadata of a person and FIG. 4 illustrates an example of the metadata of a document, and the two examples are same in that both of the two examples are configured in three-tier format of <ID, identifiers, values>. For example, in the example shown in FIG. 3, a column containing “199999” is for the ID, the column containing “Name”, “Section Assigned”, etc., is for the identifiers, and a column containing “Takuya Kimura”, “Research Section No. 1”, etc., is for the values.

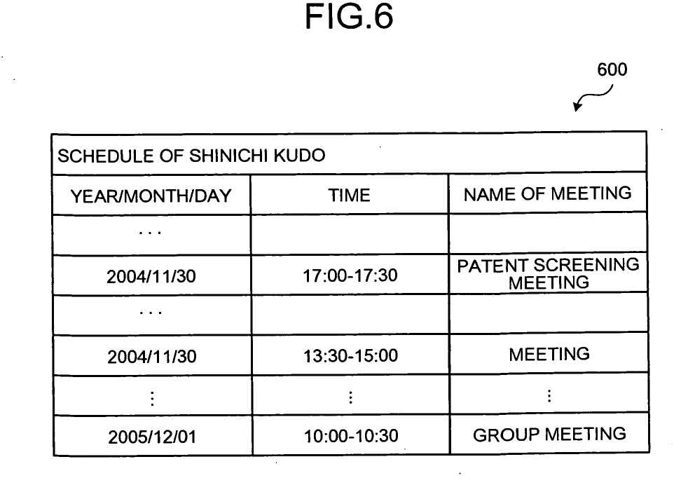

FIG. 5 and FIG. 6 illustrate examples of the metadata of the schedules. FIG. 5 shows metadata 500 of a schedule of the person named “Takuya Kimura” shown as the metadata of FIG. 3. In FIG. 5 and FIG. 6, the date and the time of meetings are identified by the year, the month, the day, and the time respectively in the metadata 500, 600 of the schedules. The names of meetings are identified respectively by the names of the meetings.

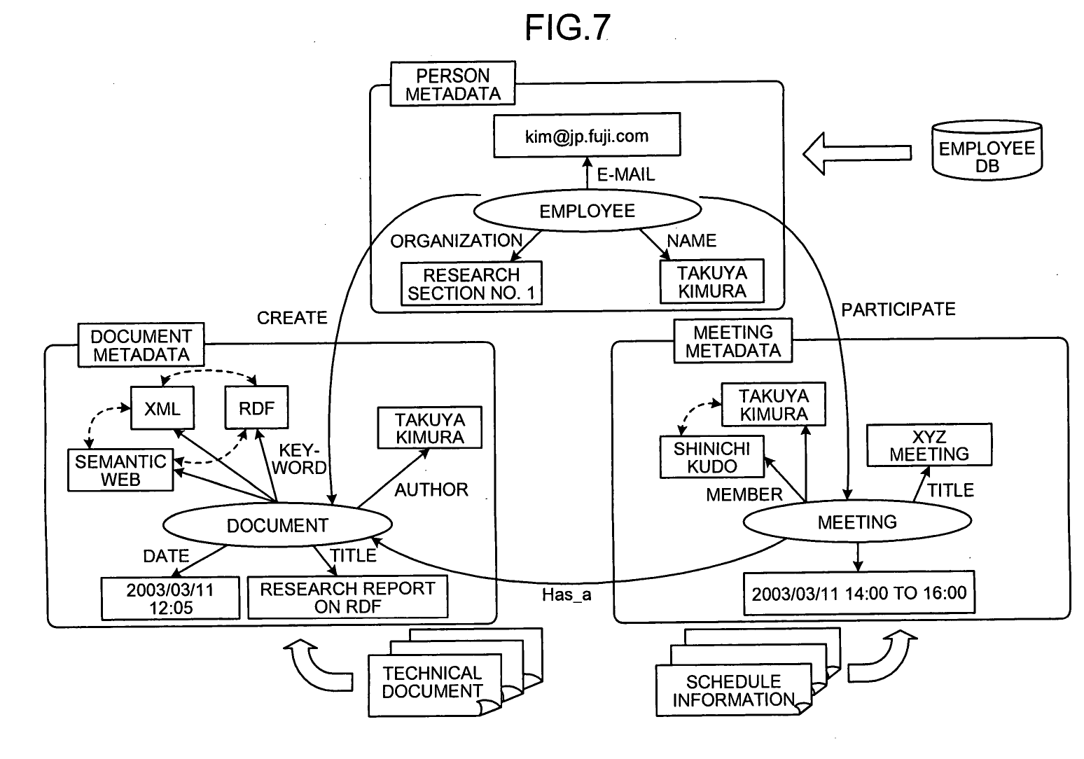

FIG. 7 is a conceptual view of a part of the metadata retained in the metadata DB 220. As shown, as to the three items of “Employee”, “Document”, and “Meeting” extracted from various types of target input information, the details of each of the items and the relationships among the items are defined. In FIG. 7, the links represented by dotted lines are the links added as a result of mining by the metadata linking unit 202. These links mainly represent co-occurrence relationships and represent the relationships among the key words that often appear in the same document, and among the people who often attend the same meeting.

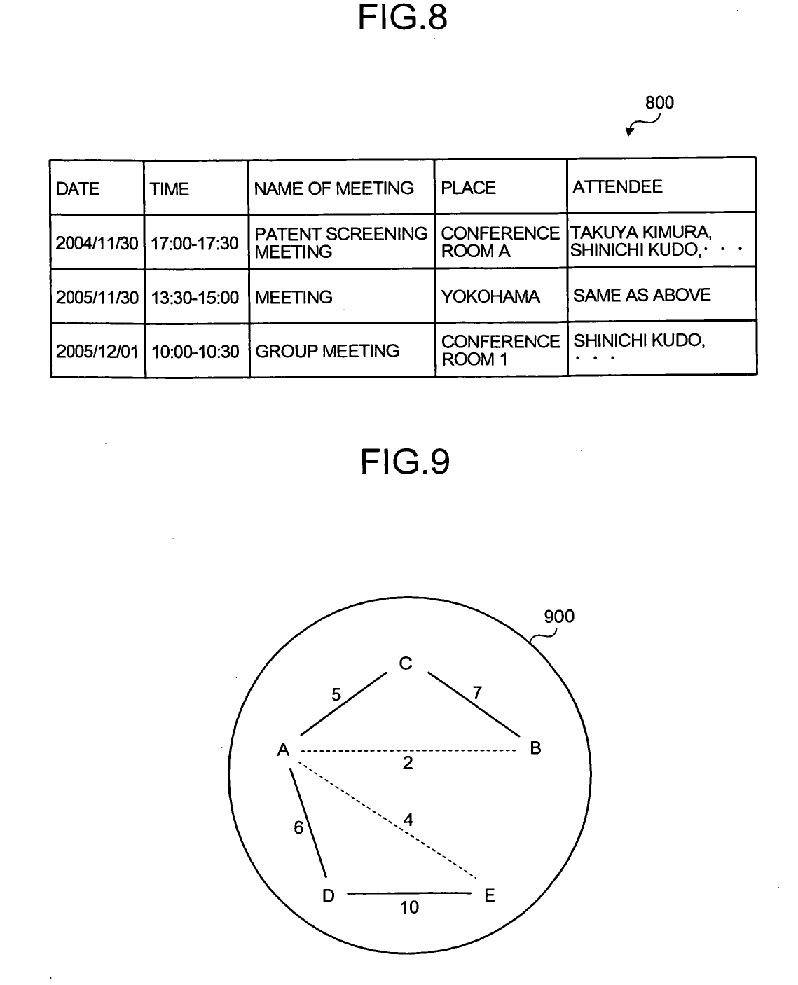

The linked metadata are data that are related with each other by the metadata linking unit 202 described above. FIG. 8 is a table showing the linked metadata of a schedule. As shown in FIG. 8, linked metadata 800 are secondary metadata obtained utilizing the metadata 500, 600 shown in FIG. 5 and FIG. 6. Because “2004/11/30 17:00-17:30 Patent Screening Meeting” and “2005/11/30 13:30-15:00 Meeting” are co-occurred in the metadata 500, 600 shown in FIG. 5 and FIG. 6, “Takuya Kimura” and “Shinichi Kudo” who both have attended the two meetings are related as attendees in FIG. 8.

FIG. 9 to FIG. 11 are schematics for illustrating relationships among people associated by the linked metadata. The strength of each relationship between two people is digitized and shown as the number of co-occurrences. In an example shown in FIG. 9, the number of times of attending the same meeting is the number of co-occurrences. For example, because the relationship between A and C corresponds to five points, it can be seen that the two people have attended the same meeting for five times. In FIG. 9, a threshold value of the strength (the number of times of co-occurrences) is “five”, a relationship of five times or more is represented by a solid line, and a relationship of four times or less is represented by a dotted line. The relation formed by connecting from A to E by solid lines represents an informal community 900.

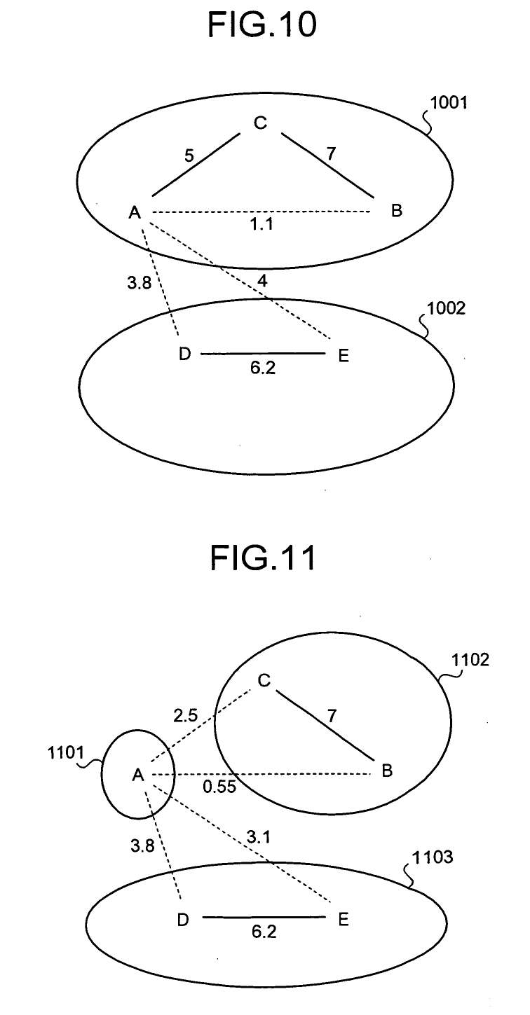

FIG. 10 illustrates an example to which the criterion <1> by the determining unit 204 is applied to the result of the linking shown in FIG. 9. In an example shown in FIG. 10, according to the rule of the criterion <1>, the number of co-occurrences is added with a weight of “+0.1” when the meeting is a meeting held between now and one year ago, and no weight is added to any meeting held before the above period. For example, between D and E, the weight is adjusted with “+0.2” because the number of co-occurrences of meetings held within one year in the past is two times, and the number of co-occurrences of meetings before that period is four times. Therefore, the strength (the number of co-occurrences after weighting) between D and E is “6.2”.

Similarly to a case shown in FIG. 9, assuming the threshold value of the strength to be “5”, two informal communities formed by connecting using solid lines exist in FIG. 10. One is an informal community 1001 consisting of A, B, and C, and the other is an informal community 1002 consisting of D and E. In this manner, a community is divided by weighting and more accurate personal relationships can be recognized.

FIG. 11 illustrates an example in which the criterion <2> by the determining unit 204 is applied to the linked result shown in FIG. 10. In an example shown in FIG. 11, under the rule of the criterion <2>, when key words, “Patent Screening Meeting” are included in the name of a meeting, the meeting is not a meeting that identifies an informal community and weighting of “×0.5” is executed. For example, because “Patent Screening Meeting” is commonly relates to A and B, the strength of the relationship between A and B is “0.55”.

Similarly, when “Patent Screening Meetings” that have been co-occurred between A and C, have all been held one year ago or before, the strength of the relationship between A and C is “2.5”. When the threshold value of the strength is defined to be “five” similarly to the case of FIG. 10, three informal communities exist in FIG. 11. One is an informal community 1101 consisting of A alone, another one is an informal community 1102 consisting of B and C, and the last one is an informal community 1103 consisting of D and E. Similarly to the case of FIG. 10, a community is divided by weighting and more accurate personal relationships can be recognized.

Communities shown in FIG. 9 to FIG. 11 are displayed on a display screen in the personal relationship displaying unit 205. Although more than one informal community exists in the examples shown in FIG. 10 and FIG. 11, some communities may disappear from the display screen when the strength of the relationship between the two people for each of those communities becomes less than five. For example, assuming that the strength of the relationship between D and E is less than five in FIG. 11, the community 1103 is to disappear.

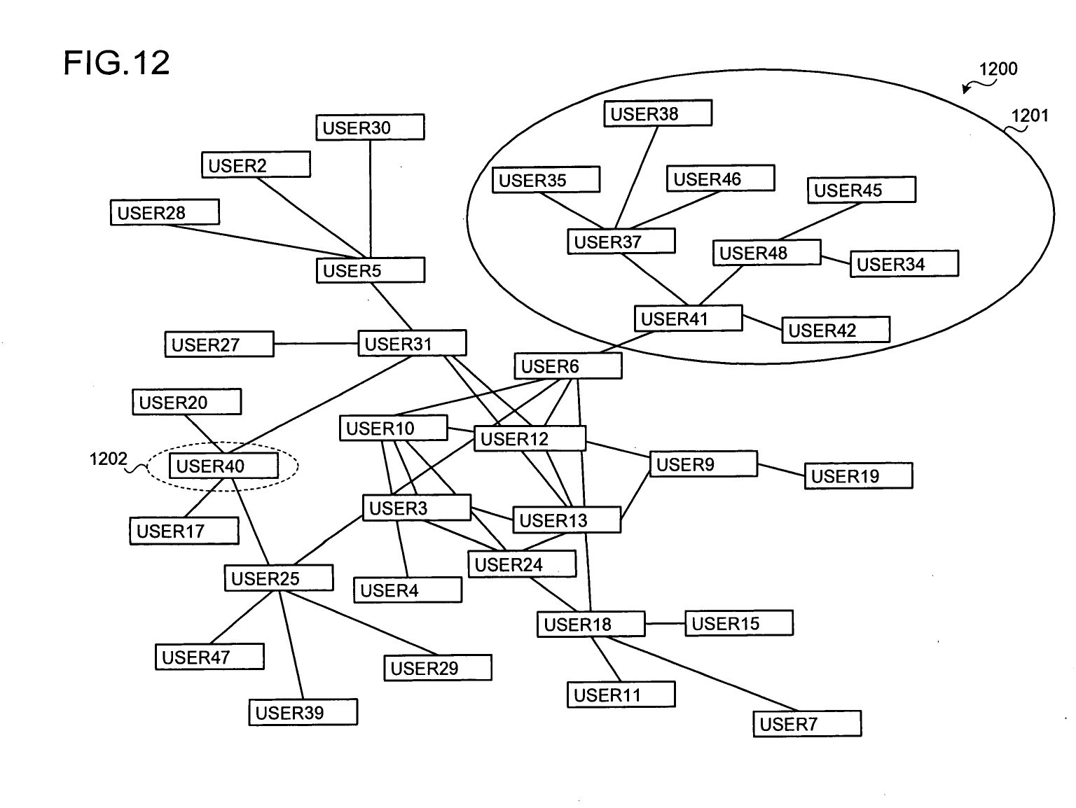

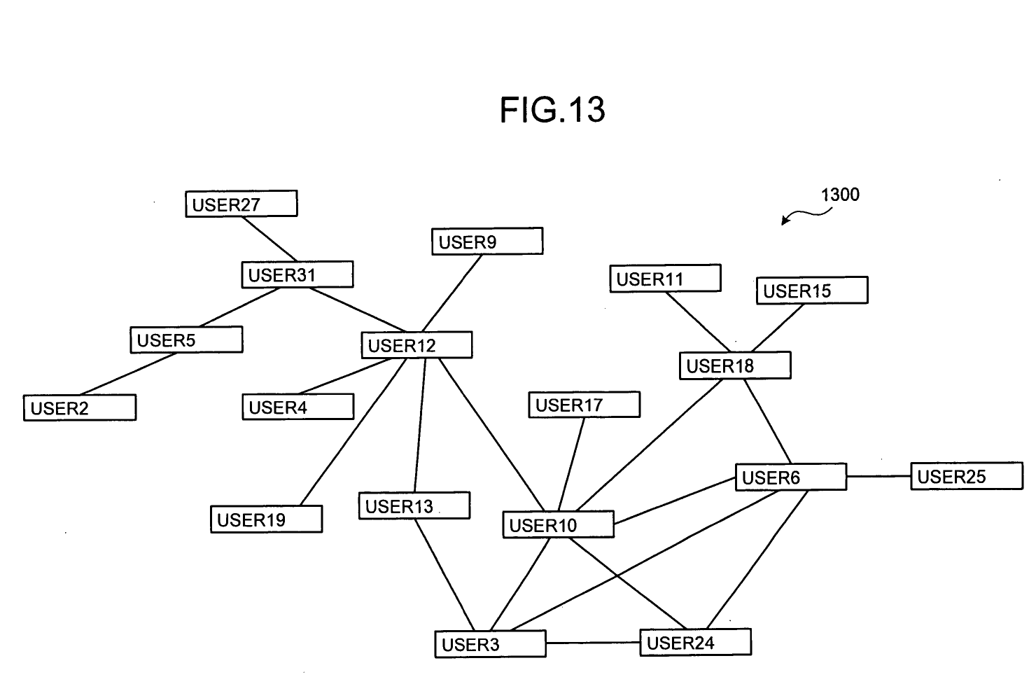

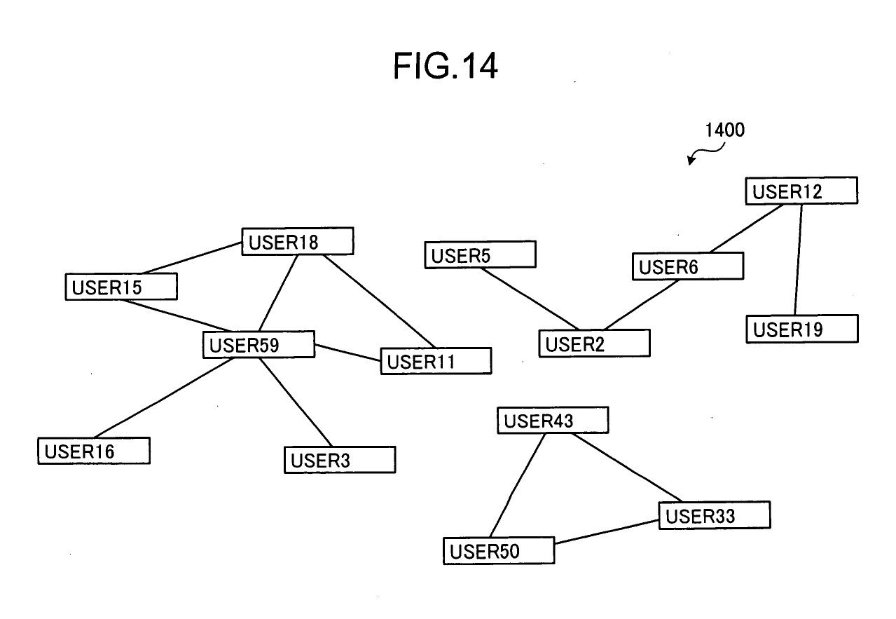

FIG. 12 is a schematic of an example of a conventional personal relationship map. FIG. 13 and FIG. 14 are schematics of displays of personal relationship maps according to the embodiment. A personal relationship map 1200 shown in FIG. 12 is a personal relationship map created without using the determining unit. An area 1201 surrounded by a solid line is a set of people (USER 34, USER 35, USER 37, USER 38, USER 41, USER 42, USER 45, USER 46, and USER 48) that have been transferred to other sections due to a personnel reshuffle. An area 1202 surrounded by a dotted line is a retired person (USER 40).

An example shown in FIG. 13 uses the same linked metadata as that of the example shown in FIG. 12. In a personal relationship map 1300 of FIG. 13, the people in the areas 1201, 1202 shown in FIG. 12 are not displayed because weighting due to the passage of time is considered by applying the criterion <1> by the determining unit 204.

By applying the criterion <2> (the criterion <3> or <4>) by the determining unit 204, a personal relationship map 1400 of FIG. 14 can be displayed. In the personal relationship map 1400 of FIG. 14, the relationships among people are displayed more accurately because the weighting by the type of meeting (instead, the number of attendees or information on sections to which the people belong may be used) is considered in addition to the passage of time.

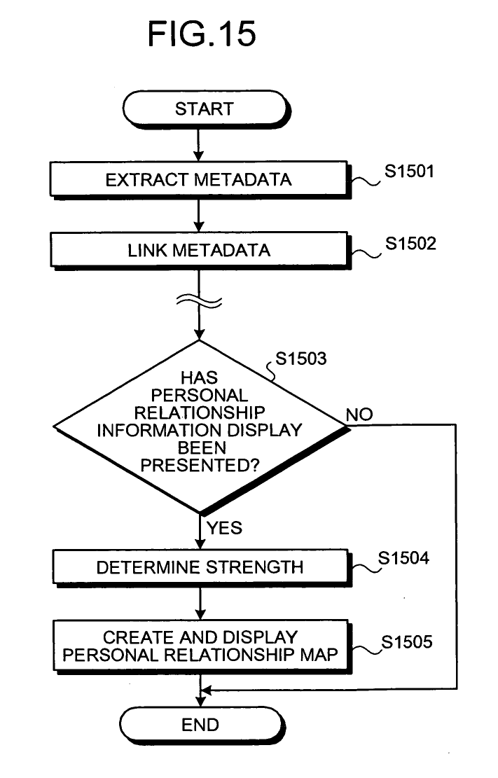

FIG. 15 is a flowchart of a display process by the personal relationship display apparatus 200. As shown in FIG. 15, the metadata are extracted by the metadata extracting unit 201 (step S1501). The extracted metadata are stored in the metadata DB 220. Metadata are linked by the metadata linking unit 202, that is, the metadata extracted by the metadata extracting unit 201 are related with each other based on co-occurrences of the personal identifying information (step S1502). For example, as shown in FIG. 8, linked metadata are generated.

Display instruction of the personal relationship information is accepted (step S1503), and when no such instruction is accepted, the procedure ends (step S1503: NO). On the other hand, when the display instruction is sent (step S1503: YES), the strength of relationships among the people is determined by the determining unit 204 relative to the date and the time at which the display instruction is sent (step S1504).

For example, as shown in FIG. 10 or FIG. 11, the strength of relationships among the people (co-occurrence) is determined. The personal relationship information (for example, the personal relationship map shown in FIG. 13 or FIG. 14) is displayed by the personal relationship displaying unit 205 based on the linked metadata and the determination result (step S1505).

According to the embodiment described above, by utilizing the metadata such as information on a schedule, noting that a relationship exists among people who respectively have an appointment on the same day at the same time at the same place, weighting is executed to the strength of a relationship among the people according to the data characteristics (for example, attenuation of time, specific key words included in the name of a meeting, the number of attendees, the type of meeting) held by the metadata such as a schedule when the relationship among the people is extracted.

Thus, unnecessary data can be deleted leaving the data necessary for extracting informal communities that are not administered by a project organization chart, etc. Therefore, informal communities can be reflected accurately and understandably.

Personal relationships relating to a project across organizations can be displayed in a wide range from various facets, always based on various types of the latest electronic data. Sub-groups in the group and contact points (people acting as bridges) among the sub-groups can be grasped. Therefore, which person will cause a trouble to the work when the person gets out of the group can be estimated to a certain degree. To realize these, collection work of the complicated data and registration work of the profiles that have been necessary in the conventional techniques are not necessary.

In the embodiment described above, as an assistance for business operation after the personal relationship map has been displayed, for example, a place suitable for holding a meeting attended by the members of a new project is picked up. However, in addition to this, the date and the time of completion of the whole work can be estimated from the schedule of each person and the time necessary for each work of the project, or the date and the time optimal for a meeting can be presented.

As described above, the personal relationship information displaying program, the recording medium recorded with the program, the personal relationship display apparatus, and the personal relationship display method of the present invention exert an effect that realistic personal relationship information can be recognized accurately and understandably.

The personal relationship display method described in the embodiment may be realized by executing a program prepared in advance, on a computer such as a personal computer, a work station, etc. This program is recorded in a computer-readable recording medium such as an HD, an FD, a CD-ROM, an MO, a DVD, etc., and is executed by being read from the recording medium by the computer. This program may be a transmission medium capable of being distributed through a network such as the Internet, etc.

According to the present invention, realistic personal relationship information can be recognized accurately and understandably.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a computer program for displaying personal relationship information, the computer program making a computer execute:
extracting a plurality of pieces of metadata each including information on a person, from electronic data that includes identification information identifying each person;
linking the pieces of the metadata with each other based on co-occurrences of the identification information;
determining strength of each relationships between people in liked pieces of the metadata, based on identification information that is used to link the pieces of the metadata at the linking; and
graphically displaying the relationship based on the linked pieces of metadata and the strength of relationships.

2. The computer-readable recording medium according to claim 1, wherein
the identification information includes information on a meeting the person attends, and
the determining includes determining the strength based on number of days that have passed since the meeting.

3. The computer-readable recording medium according to claim 1, wherein
the identification information includes information on a meeting the person attends, and
the determining includes determining the strength based on a type of the meeting.

4. The computer-readable recording medium according to claim 1, wherein
the identification information includes information on a meeting the person attends, and
the determining includes determining the strength based on number of attendees of the meeting.

5. The computer-readable recording medium according to claim 1, wherein
the identification information includes information on a meeting the person attends and a section to which the person belongs, and
the determining includes determining the strength based on the section of attendees of the meeting.

6. An apparatus for displaying information on personal relationship, comprising:
an extracting unit configured to extract a plurality of pieces of metadata each including information on a person, from electronic data that includes identification information identifying each person;
a linking unit configured to link the pieces of the metadata with each other based on co-occurrences of the identification information;
a determining unit configured to determine strength of relationships between people in liked pieces of the metadata, based on identification information that is used by the linking unit to link the pieces of the metadata; and
a displaying unit configured to graphically display the relationships based on the linked pieces of metadata and the strength of relationships.

7. The apparatus according to claim 6, wherein
the identification information includes information on a meeting the person attends, and
the determining unit is configured to determine the strength based on number of days that have passed since the meeting.

8. The apparatus according to claim 6, wherein
the identification information includes information on a meeting the person attends, and
the determining unit is configured to determine the strength based on a type of the meeting.

9. The apparatus according to claim 6, wherein
the identification information includes information on a meeting the person attends, and
the determining unit is configured to determine the strength based on number of attendees of the meeting.

10. The apparatus according to claim 6, wherein
the identification information includes information on a meeting the person attends and a section to which the person belongs, and
the determining unit is configured to determine the strength based on the section of attendees of the meeting.

11. A method of displaying personal relationship information, comprising:
extracting a plurality of pieces of metadata each including information on a person, from electronic data that includes identification information identifying each person;
linking the pieces of the metadata with each other based on co-occurrences of the identification information;
determining strength of each relationships between people in liked pieces of the metadata, based on identification information that is used to link the pieces of the metadata at the linking; and
graphically displaying the relationship based on the linked pieces of metadata and the strength of relationships.

12. The method according to claim 11, wherein
the identification information includes information on a meeting the person attends, and
the determining includes determining the strength based on number of days that have passed since the meeting.

13. The method according to claim 11, wherein
the identification information includes information on a meeting the person attends, and
the determining includes determining the strength based on a type of the meeting.

14. The method according to claim 11, wherein
the identification information includes information on a meeting the person attends, and
the determining includes determining the strength based on number of attendees of the meeting.

15. The method according to claim 11, wherein
the identification information includes information on a meeting the person attends and a section to which the person belongs, and
the determining includes determining the strength based on the section of attendees of the meeting.
